(19) United States
(12) Patent Application Publication
(10) Pub. No.: US 2016/0275397 A1
(43) Pub. Date: Sep. 22, 2016

(54) METHOD AND APPARATUS FOR EVENT-BASED LEARNING IN NEURAL NETWORK

(71) Applicants: SAMSUNG ELECTRONICS CO., LTD., Suwon-si (KR); Universitaet Zuerich, Zuerich (CH)

(72) Inventors: Daniel NEIL, Zuerich (CH); Michael PFEIFFER, Zuerich (CH); Shih- Chii LIU, Zuerich (CH)

(73) Assignees: Universitaet Zuerich, Zuerich (CH); SAMSUNG ELECTRONICS CO., LTD., Suwon-si (KR)

(21) Appl. No.: 14/833,264

(22) Filed: Aug. 24, 2015

(30) Foreign Application Priority Data
Mar. 18, 2015 (KR) 10-2015-0037427

(51) Int. Cl. G06N 3/08; G06N 3/10; G06N 99/00

(52) U.S. Cl. CPC G06N 3/08; G06N 99/005; G06N 3/10

(57) ABSTRACT

A machine-learning method is provided, in which a restricted Boltzmann Machine (RBM) is modified to be effectively operate in an online environment by training a learning parameter asynchronously based on spiking events which occurs only when a spiking timing of a visual layer and a spiking timing of a hidden layer are within predetermined time window.

### CROSS-REFERENCE TO RELATED APPLICATION

This application claims priority from Korean Patent Application No. 10-2015-0037427, filed on Mar. 18, 2015 in the Korean Intellectual Property Office, the disclosure of which is incorporated herein by reference in its entirety.

### BACKGROUND

1. Field

Methods and apparatuses consistent with exemplary embodiments relate to a machine learning method and apparatus.

2. Description of the Related Art

A brain has hundreds of billions of nerve cells, or neurons, which form a complex neural network. A neuron may exhibit intellectual abilities in learning, memory, and the like through a synapse that sends and receives a signal with thousands of other neurons. A neuron is a structural and functional unit in a nervous system, and a fundamental unit in information transfer. A synapse may refer to a junction among neurons, and a portion at which axons of a neuron are connected to dendrites of another neuron. A neuron may be connected to thousands of other neurons through a synapse. A neuromorphic chip is a semiconductor circuit manufactured in a neuronal level from an artificial neural system which simulates a biological neural system to perform an information processing method similar to a method performed by a human brain. A communication channel may be used to read an event signal generated from a neuron included in the neuromorphic chip or transfer the event signal to another neuron.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

According to an aspect of an exemplary embodiment, there is provided a method for a machine-learning apparatus to train a learning parameter for simulating a neural network, the method including: activating a first visible layer based on input data; activating a first hidden layer based on a first learning parameter of the first visible layer and the first hidden layer and an output of the first visible layer; training the first learning parameter based on the output of the first visible layer and an output of the first hidden layer; activating a second visible layer corresponding to an auxiliary layer of the first visible layer based on the output of the first hidden layer; activating a second hidden layer corresponding to an auxiliary layer of the first hidden layer based on a second learning parameter of the second visible layer and the second hidden layer and an output of the second visible layer; and training the second learning parameter based on the output of the second visible layer and an output of the second hidden layer.

The first learning parameter may represent a connection structure between the first visible layer and the first hidden layer, the second learning parameter may represent a connection structure between the second visible layer and the second hidden layer, and the first learning parameter is identical to the second learning parameter.

The training the first learning parameter may include training the first learning parameter so that the output of the first hidden layer is similar to the input data, and the training the second learning parameter may include training the second learning parameter so that the output of the second visible layer is similar to the output of the first visible layer.

The first learning parameter may include a first connection weight between a neuron in the first visible layer and a neuron in the first hidden layer, and the second learning parameter may include a second connection weight between a neuron in the second visible layer and a neuron in the second hidden layer.

Neurons in the first visible layer, the first hidden layer, the second visible layer, and the second hidden layer may be activated based on a timing of a spike to be input.

The first connection weight between a first visible neuron in the first visible layer and a first hidden neuron in the first hidden layer may increase based on an output of the first visible neuron and an output of the first hidden neuron, and the second connection weight between a second visible neuron in the second visible layer and a second hidden neuron in the second hidden layer may decrease based on an output of the second visible neuron and an output of the second hidden neuron.

The first connection weight between the first visible neuron and the first hidden neuron may increase when a timing of a spike output by the first visible neuron and a timing of a spike output by the first hidden layer are within a predetermined time range.

The second connection weight between the second visible neuron and the second hidden neuron may decrease when a timing of a spike output by the second visible neuron and a timing of a spike output by the second hidden layer are within a predetermined time range.

According to another aspect of an exemplary embodiment, there is provided a learning apparatus including a storage configured to store a computer program including instructions to simulate a neural network; and a processor configured to perform a method for training a learning parameter used in the neutral network by executing the computer program, the method including: activating a first visible layer based on input data; activating a first hidden layer based on a first learning parameter of the first visible layer and the first hidden layer and an output of the first visible layer; training the first learning parameter based on the output of the first visible layer and an output of the first hidden layer; activating a second visible layer corresponding to an auxiliary layer of the first visible layer based on the output of the first hidden layer; activating a second hidden layer corresponding to an auxiliary layer of the first hidden layer based on a second learning parameter of the second visible layer and the second hidden layer and an output of the second visible layer; and training the second learning parameter based on the output of the second visible layer and an output of the second hidden layer.

The first learning parameter may represent a connection structure between the first visible layer and the first hidden layer, the second learning parameter may represent a connection structure between the second visible layer and the second hidden layer, and the first learning parameter is identical to the second learning parameter.

The training the first learning parameter may include training the first learning parameter so that the output of the first hidden layer is similar to the input data, and the training the second learning parameter may include training the second learning parameter so that the output of the second visible layer is similar to the output of the first visible layer.

The first learning parameter may include a first connection weight between a neuron in the first visible layer and a neuron in the first hidden layer, and the second learning parameter may include a second connection weight between a neuron in the second visible layer and a neuron in the second hidden layer.

Neurons in the first visible layer, the first hidden layer, the second visible layer, and the second hidden layer may be activated based on a timing of a spike to be input.

The first connection weight between a first visible neuron in the first visible layer and a first hidden neuron in the first hidden layer may increase based on an output of the first visible neuron and an output of the first hidden neuron, and the second connection weight between a second visible neuron in the second visible layer and a second hidden neuron in the second hidden layer may decrease based on an output of the second visible neuron and an output of the second hidden neuron.

The first connection weight between the first visible neuron and the first hidden neuron may increase when a timing of a spike output by the first visible neuron and a timing of a spike output by the first hidden layer are within a predetermined time range.

The second connection weight between the second visible neuron and the second hidden neuron may decrease when a timing of a spike output by the second visible neuron and a timing of a spike output by the second hidden layer are within a predetermined time range.

### BRIEF DESCRIPTION OF THE DRAWINGS

The above and other aspects of exemplary embodiments will become apparent and more readily appreciated from the following detailed description of exemplary embodiments, taken in conjunction with the accompanying drawings of which:

FIGS. 1A and 1B are diagrams illustrating deep learning mechanism according to an exemplary embodiment;

FIG. 2 is a diagram illustrating a structure of a restricted Boltzmann machine (RBM) according to an exemplary embodiment;

FIG. 3 is a flowchart illustrating a machine-learning method according to an exemplary embodiment;

FIG. 4 is a diagram illustrating an operation of a learning apparatus according to an exemplary embodiment;

FIG. 5 is a diagram illustrating how each layer of a simulated neural network is activated by spikes received from neurons according to an exemplary embodiment;

FIG. 6 is a diagram illustrating a method of updating a weight based on a learning rule in a learning apparatus according to an exemplary embodiment;

FIGS. 7A and 7B are diagrams illustrating a timing-based learning scheme in a learning apparatus according to an exemplary embodiment; and

FIG. 8 is a block diagram of a learning apparatus according to an exemplary embodiment.

### DETAILED DESCRIPTION

Reference will now be made in detail to exemplary embodiments, examples of which are illustrated in the accompanying drawings, wherein like reference numerals refer to the like elements throughout. Exemplary embodiments are described below with reference to the figures.

The features described herein may be embodied in different forms, and are not to be construed as being limited to the examples described herein. Rather, the examples described herein have been provided so that the disclosure is thorough, complete, and conveys the full scope of the disclosure to one of ordinary skill in the art.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “include” and/or “have,” when used in this disclosure, specify the presence of stated features, integers, steps, operations, elements, components or combinations thereof, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this disclosure belongs. For example, “unit”, “node”, and “neuron” may have the same meaning in the field of machine-learning based on a neural network.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

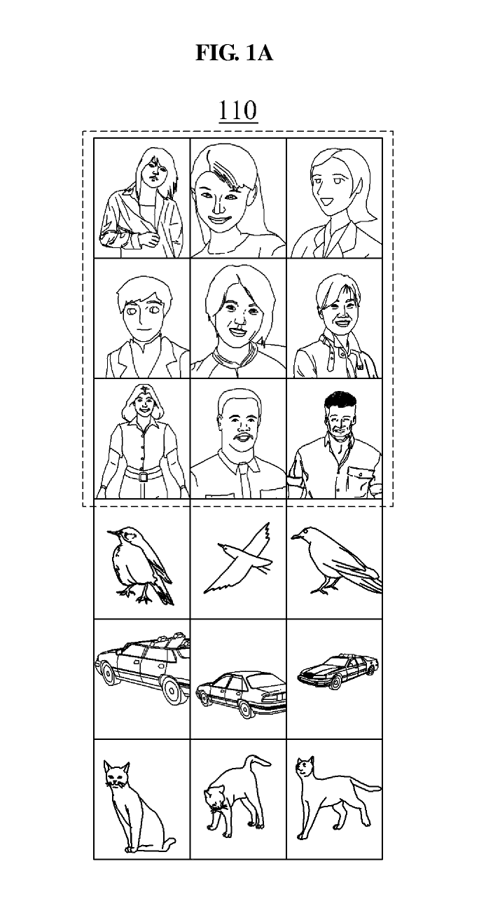

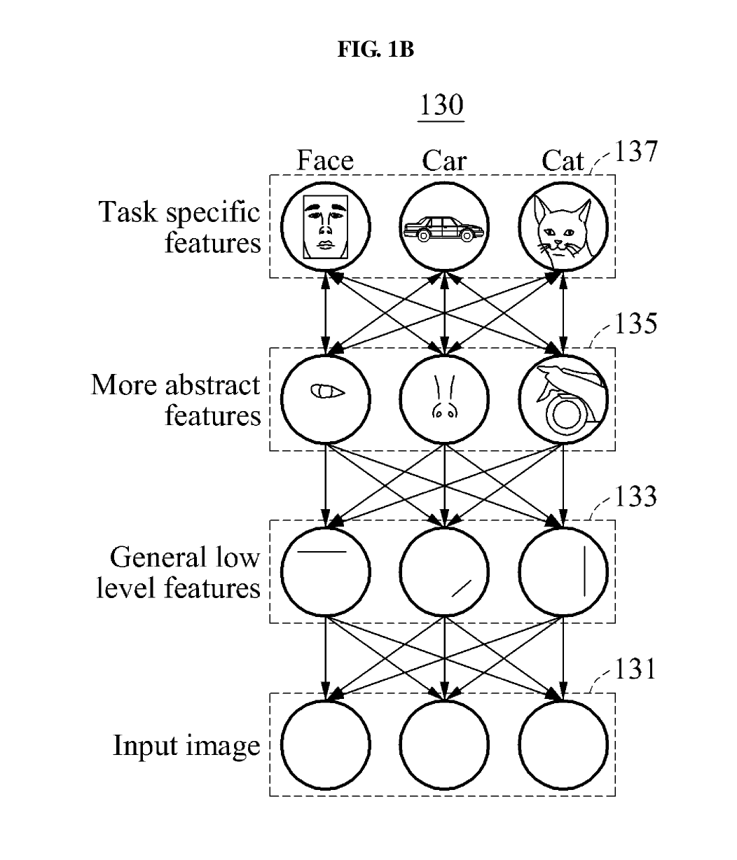

FIGS. 1A and 1B are diagrams illustrating deep learning mechanism according to an exemplary embodiment.

The deep learning is an approach used in a field of machine learning to tackle complex issues relating to, for example, image recognition and voice or speech recognition, from large-scale data sets. A main idea of the deep learning is extracting a functional hierarchical structure 130 of a multilayered neural network using a supervised learning method, an unsupervised learning method, or a combination thereof.

A deep belief network (DBN) which is formed in a layered structure of simple recurrent neural networks (RNNs) also referred to as restricted Boltzmann machines (RBMs) may be used as a model for the deep learning.

An RBM may be learned by each layer through the unsupervised learning method called contrastive divergence (CD). For example, the RBM may gradually extract visual objects or abstract features that enable pattern recognition such as, for example, voice or speech recognition. Although neurons in a same layer are not interconnected in the RBM, the RBM includes two layers, for example, a visible layer and a hidden layer, of bilaterally connected neurons. The visible layer may receive input data, and the hidden layer may learn the extracted features and reconstruct an input from the learned features.

Activation of neurons included in the hidden layer subsequent to learning performed once in the RBM may be used as an input to a subsequent RBM in a class of the DBN. For example, the DBN may function as a generative model of data in addition to data classification. For example, in the presence of occlusions, missing values, or ambiguous data, the DBN may encode a probability distribution of an input set that may be sampled by a network, and merger inputs in different sensory modalities by operations in a feedforward and a feedback direction.

The following two issues may be considered for actual implementation of the deep learning. First, general deep networks implementing the deep learning may be extremely large and thus, impractical for real-time application programs using computing technology. In addition, learning in a general deep network may be time consuming and use a significant amount of computing resources due to a large size and a large-scale data set.

According to exemplary embodiments, using a method of mapping the DBN to a spiking neural network (SNN), a deep neural network (DNN) or the DBN in particular, may be implemented as an effective method suitable for real-time implementation. In such a structure, event signals to be output from an event-based sensor may be processed in real time by a unit of milliseconds. According to exemplary embodiments, a spiking DBN may be learned using Siegert approximation on a firing rate of a spiking integrate-and-fire (IF) neuron or using variations of a classical CD learning rule.

According to exemplary embodiments, a learning apparatus may use a spiking-based learning rule. For example, the learning apparatus may use an event-based online CD learning rule for the RBM and DBN which use the spiking-based learning rule. The spiking-based learning rule may be used to directly learn weights of spiking RBMs including auxiliary neuron sets.

Using such learning rules may enable the DNN to rapidly adapt to observed data and an online environment. According to exemplary embodiments, learning or training may be performed through parallelization in neuromorphic hardware including dedicated circuits of neurons and synapses, rather than sequential computer simulation. Such a parallelization method may have a huge potential for fast learning in the DNN.

The learning apparatus may be directly learned from event streams to be input from neuromorphic sensors such as, for example, dynamic vision sensors, and address event representation (AER)-EAR silicone or silicon cochleae. AER indicates a method of recording an address of a neuron at which a spike event is generated from a communication bus, asynchronously to a timing at which the spike event is generated.

According to exemplary embodiments, an online learning method for a learning apparatus may permit approximate values in unsupervised probabilistic learning through spike-timing dependent plasticity (STDP) and a local plasticity rule similar to a biologically plausible form of learning.

FIG. 1A illustrates mixed data 110, and FIG. 1B illustrates a multilayered neural network 130 having a functional hierarchical structure. A neural network may learn extraction of a gradually greater number of abstract features from different layers by learning the mixed data 110 in the multilayered neural network 130.

Referring to FIG. 1B, input images 131 may be from a bottom layer in the multilayered neural network 130. A first layer 133 may learn extraction of a simple geometrical feature at a generally low level, for example, line segments including a horizontal line, a vertical line, a diagonal line, and the like. A second layer 135 may learn extraction of more abstract features such as, for example, an eye, a nose, and wheels, based on contents of a data set. A final third layer 137 may form abstract representations of inputs of different classes, for example, a face, a car, and an animal. The formed abstract representations may be more easily distinguished from original pixel images. The third layer 137 may be also referred to as a task specific layer.

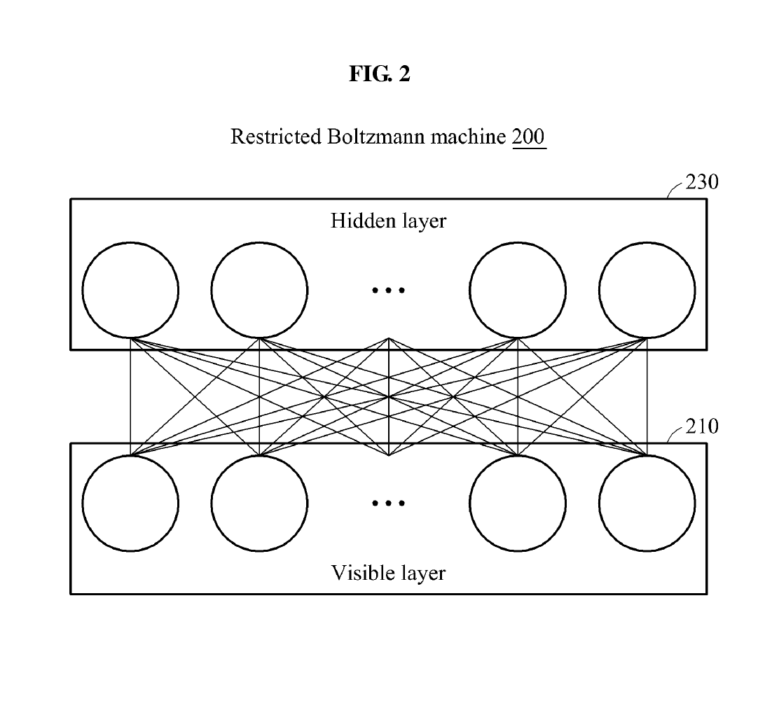

FIG. 2 is a diagram illustrating a structure of an RBM 200 according to an exemplary embodiment.

Referring to FIG. 2, the RBM 200 includes a visible layer 210 and a hidden layer 230. In the RBM 200, an input may be applied to the visible layer 210, and the visible layer 210 and the hidden layer 230 may be completely and recurrently connected. The visible layer 210 may correspond to data to be applied to the RBM 200, and the hidden layer 230 may correspond to an abstract representation hidden from an outside world.

In the RBM 200, units in a same layer may not be connected, for example, individual neurons in the visible layer 210 and individual neurons in the hidden layer 230. A weight may be learned to allow input activation to be optimally reconstructed from a low level feature representation of the hidden layer 230.

The RBM 200 may be learned using a computation-intensive processor which is annealed with low energy states. Such states may be used to provide guidance to a learning algorithm which models joint probabilities of an input presented to the RBM 200.

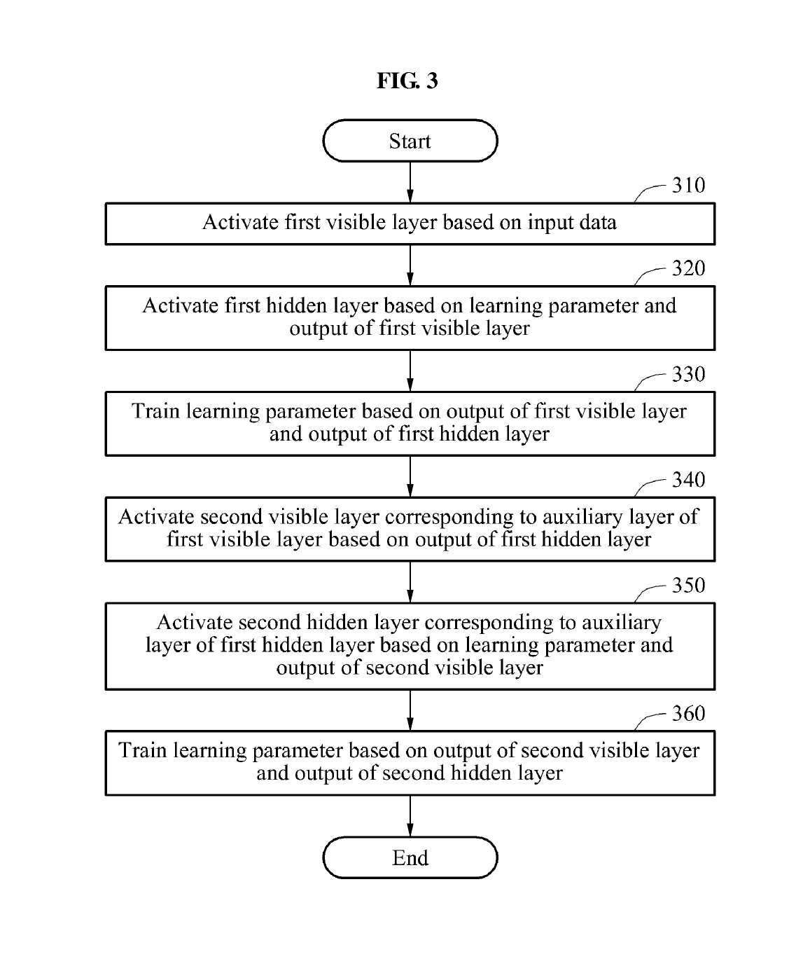

FIG. 3 is a flowchart illustrating a machine-learning method according to an exemplary embodiment. The learning method to be described hereinafter may be performed by a learning apparatus.

Referring to FIG. 3, in operation 310, the learning apparatus activates a first visible layer based on input data. In operation 320, the learning apparatus activates a first hidden layer based on a learning parameter and an output of the first visible layer. In operation 330, the learning apparatus trains the learning parameter based on the output of the first visible layer and an output of the first hidden layer. The activation of the first visible layer and the first hidden layer, and the training of the learning parameter will be further described.

In operation 340, the learning apparatus activates a second visible layer based on an output of the first hidden layer. The second visible layer corresponds to an auxiliary layer of the first visible layer. In operation 350, the learning apparatus activates a second hidden layer based on a learning parameter and an output of the second visible layer. The second hidden layer corresponds to an auxiliary layer of the first hidden layer. A connection structure between the second visible layer and the second hidden layer may be identical to a connection structure between the first visible layer and the first hidden layer. In operation 360, the learning apparatus trains the learning parameter based on the output of the second visible layer and an output of the second hidden layer. The activation of the second visible layer and the second hidden layer, and the training of the learning parameter will be further described.

The first visible layer, the first hidden layer, the second visible layer, and the second hidden layer may include respective neurons. Neurons included in each layer may be activated based on a timing of a spike to be input.

The learning parameter may be trained for the output of the first hidden layer to be similar to the input data, or for the output of the second visible layer to be similar to the output of the first visible layer. The learning parameter may include, but is not limited to, a connection weight between a neuron included in a visible layer and a neuron included in a hidden layer.

A connection weight between a first visible neuron included in the first visible layer and a first hidden neuron included in the first hidden layer may increase based on an output of the first visible neuron and an output of the first hidden neuron. A connection weight between a second visible neuron included in the second visible layer and a second hidden neuron included in the second hidden layer may decrease based on an output of the second visible neuron and an output of the second hidden neuron.

The connection weight between the first visible neuron and the first hidden neuron may increase when a difference between a timing of a spike to be output by the first visible neuron and a timing of a spike to be output by the first hidden layer is within a predetermined time range. The time range may be a timing window to be described hereinafter. The connection weight between the second visible neuron and the second hidden neuron may decrease when a difference between a timing of a spike to be output by the second visible neuron and a timing of a spike to be output by the second hidden layer is within a predetermined time range.

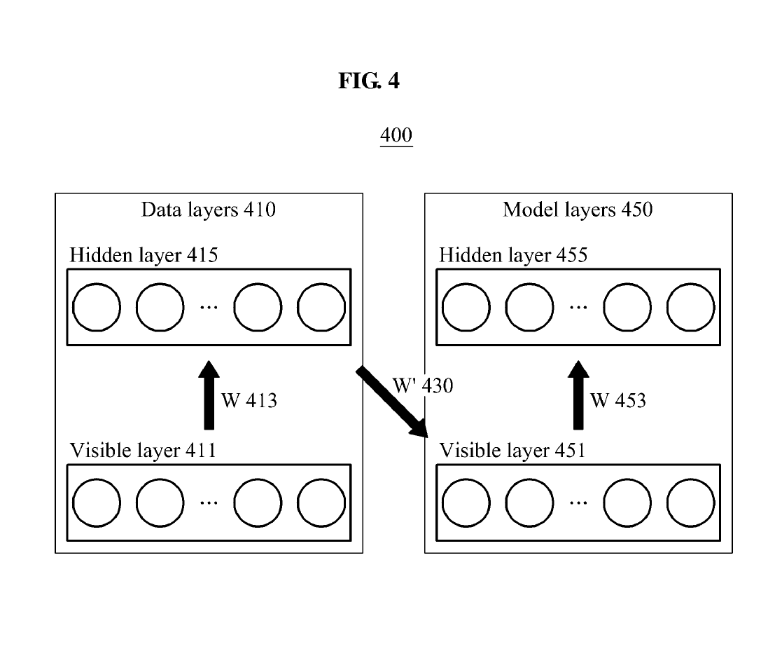

FIG. 4 is a diagram illustrating an operation of a learning apparatus 400 according to an exemplary embodiment.

Referring to FIG. 4, the learning apparatus 400 includes data layers 410 performing a data-driven operation and model layers 450 performing a model-driven operation. The model layers 450 include auxiliary neurons corresponding to spiking neurons included in the data layers 410.

The learning apparatus 400 includes two auxiliary layers, for example, a visible layer 451 and a hidden layer 455, including auxiliary neurons to enable STDP-based online learning. An operation of the learning apparatus 400 may be classified into two phases, for example, a first phase and a second phase. The first phase may be performed in the data layers 410 and the second phase may be performed in the model layers 450.

In the first phase, hidden values of a hidden layer 415 may be inferred from a visible unit activity of a visible layer 411. In the second phase, a visible activity of the visible layer 451 may be determined based on an output of the hidden layer 415. For example, in the second phase, the visible activity of the visible layer 451 may correspond to the output of the hidden layer 415. Alternatively, in the second phase, the visible activity of the visible layer 451 may be reconstructed by a connection weight (W′) 430 learned based on the output of the hidden layer 415.

The hidden layer 415 of the data layers 410 may receive an actual data input through the visible layer 411, and project the input to the visible layer 451 of the model layers 450. The visible layer 451 may project the input to the hidden layer 455.

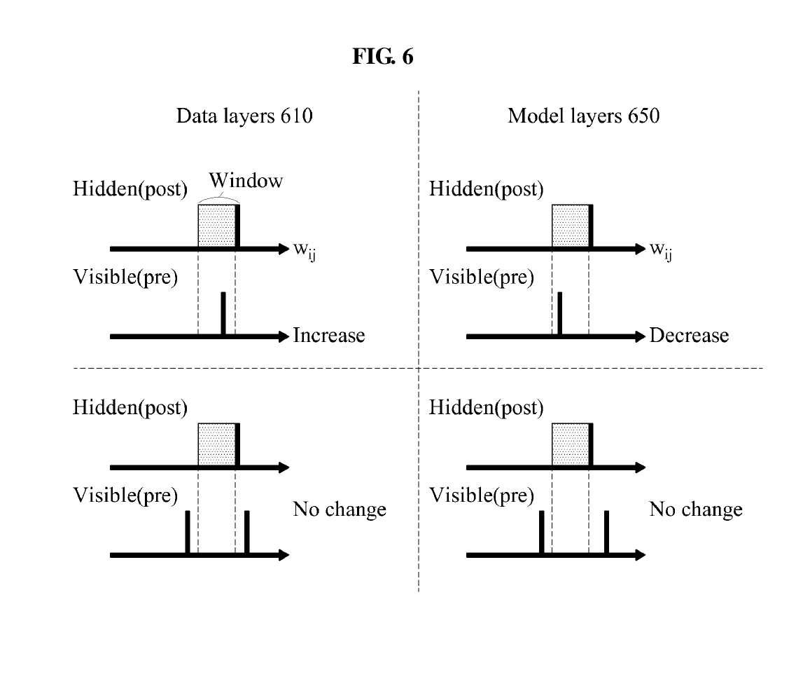

Weights, for example, a weight (W) 413 and a weight (W) 453, may be shared between the data layers 410 and the model layers 450. The weights 413 and 453 may change before a postsynaptic neuron spikes or after a presynaptic neuron spikes in a given time window. The time window will be explained in more detail with reference to FIG. 6.

The W 413 to be applied to the hidden layer 415 from the visible layer 411 of the data layers 410 may increase when neurons in the visible layer 411 spike before neurons in the hidden layer 415 spike. The W 453 to be applied to the hidden layer 455 from the visible layer 451 of the model layers 450 may decrease when neurons in the hidden layer 455 spike after neurons in the visible layer 451 spike.

The learning apparatus 400 may use an RBM used for event-based CD (hereinafter, “evtCD”). The RBM may be used to utilize energy dynamics of a system to learn a dense representation of a distribution of input data. The distribution of the input data may be specified through recurrent and symmetric connection weights that force a hidden unit to learn sparse features. The distribution may be reconstructed based on the weights 413 and 453, and may allow the RBM corresponding to the system to bring a low energy state.

In a flow of information in the RBM, new data may activate the visible layer 411. Subsequently, all units in the hidden layer 415 may be stochastically updated using a weight matrix of the RBM and a well-known stochastic sampling method such as Gibbs sampling. Activation of all the units in the data layers 410 may be driven by the input data.

The visible layer 451 may be re-sampled using the Gibbs sampling from activation of hidden neurons in the hidden layer 415. Such a re-sampling indicates model-based reconstruction of the input data, from which the term “model layer” originates. In a well-trained RBM, an input re-sampled in the model layers 450 may be similar to an original input to the data layers 410.

The hidden layer 455 may be re-sampled from visible neurons in the visible layer 451 of the model layers 450. In a general RBM, the same units are used in a hidden layer and a visible layer. However, the learning apparatus 400 may generate auxiliary units and enable learning by separating the auxiliary units into individual sets.

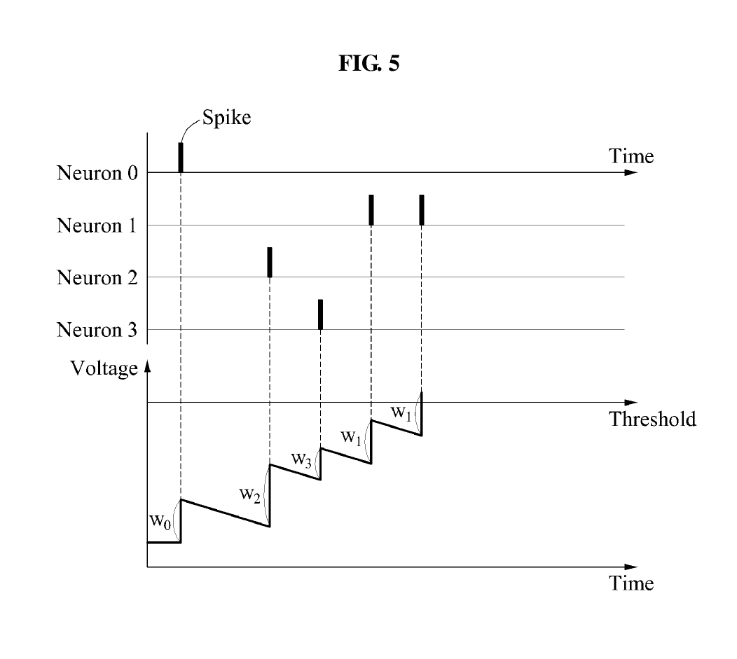

FIG. 5 is a diagram illustrating how each layer of a simulated neural network is activated by spikes received from other layer according to an exemplary embodiment. In this exemplary embodiment, it is assumed that the visible layer 411 of the data layers 410 of FIG. 4 includes four neurons, for example, neuron 0, neuron 1, neuron 2, and neuron 3, and each neuron is connected to neuron 7 in the hidden layer 415 of the data layers 410, and the neurons include different spiking timings and different weights.

When neuron 0 spikes, a voltage of neuron 7 in the hidden layer 415 may increase by a voltage in which a weight (w₀) between neuron 0 and neuron 7 is reflected. The voltage of neuron 7 may gradually decrease over time. Here, the voltage of neuron 7 does not exceed a threshold voltage value and thus, an output value of neuron 7 is 0.

Subsequently, when neuron 2 spikes, the voltage of neuron 7 may increase by a voltage in which a weight (w₂) between neuron 2 and neuron 7 is reflected, based on a value decreased after neuron 0 spikes. The voltage of neuron 7 may exceed the threshold voltage value due to spiking of neuron 3 and two successive spiking of neuron 1. When the voltage of neuron 7 exceeds the threshold voltage value, neuron 7 may then spike. The spiking of neuron 7 may indicate that neuron 7 outputs 1.

FIG. 6 is a diagram illustrating a method of updating a weight based on a learning rule in a learning apparatus according to an exemplary embodiment.

In FIG. 6, a time window and a spike fired in each layer are illustrated. Here, the time window is assumed as a time window in which a spike of a hidden node in a hidden layer and a spike of a visible node in a visible layer are interconnected. The learning rule used may be based on concepts of CD and probabilistic STDP learning rules.

The learning rule may differently operate for a spike among neurons in data layers 610 and a spike among neurons in model layers 650. For example, among visible neurons in a visible layer of the data layers 610 and hidden neurons in a hidden layer of the data layers 610, a pair of spikes occurring within a given time window may induce an increase in a weight. Conversely, among visible neurons in a visible layer of the model layers 650 and hidden neurons in a hidden layer of the model layers 650, a pair of spikes occurring in the time window may induce a decrease in a weight.

When spikes are not fired within the time window, no change may occur in both the data layers 610 and the model layers 650. Such a rule may be same as in general CD learning.

Units of an RBM may be represented by stochastic binary neurons. For example, states of neurons may be encoded using networks including spiking neurons of a simple leaky integrate-and-fire (LIF) type. A network may be represented as four physically distinguished sets of spiking neurons, for example, data visible (^{v+}) and data hidden (^{h+}) in the data layers 610, and a visible model (^{v-}) and a hidden model (^{h-}) in the model layers 650.

Distributions of the data layers 610 and the model layers 650 share weight matrices and thus, magnitudes of the weight matrices may be identical. However, magnitudes of the visible layers and the hidden layers in each of the data layers 610 and the model layers 650 may be determined based on constraints. According to exemplary embodiments, the learning apparatus may have no intra-layer connection, and weights may spread whether each visible layer and hidden layer is activated. Weights (W′) between a hidden layer of data layers and a visible layer in model layers may be a transposition of forward weights (W) in the data layers or the model layers. Here, weights may have a form of a matrix.

In an example, a evtCD learning rule may be expanded for learning of a weight matrix. An evtCD updating rule may be summarized as in Equation 1.

$$Δ {w}_{ij}^{+} = \{ \begin{matrix}η if {h}_{i}^{+} = 1 , & {v}_{j}^{+} = 1 \\ 0 & otherwise\end{matrix} , \\ Δ {w}_{ij}^{-} = \{ \begin{matrix}- η if {h}_{i}^{-} = 1 , & {v}_{j}^{-} = 1 \\ 0 & otherwise\end{matrix} \\ Δ {w}_{ij} = Δ {w}_{ij}^{+} + Δ {w}_{ij}^{-} \qquad [ Equation 1 ]$$

In Equation 1, “Δwᵢⱼ” denotes a change in a connection weight between a j-th neuron in a visible layer and an i-th neuron in a hidden layer. When a neuron spikes, for example, a neuron outputs a spike, a value of the neuron may be 1. Conversely, when a neuron does not spike, a value of the neuron may be 0.

Such an equation may lead to an increase in a weight when a spike occurs in both a visible layer and a hidden layer of data layers, and to a decrease in a weight when a spike occurs in both a visible layer and a hidden layer of model layers. The learning apparatus may use an event-driven CD learning algorithm that uses a spike-timing based learning rule and an auxiliary set of neurons. The learning apparatus may implement event-based asynchronism of the learning rule.

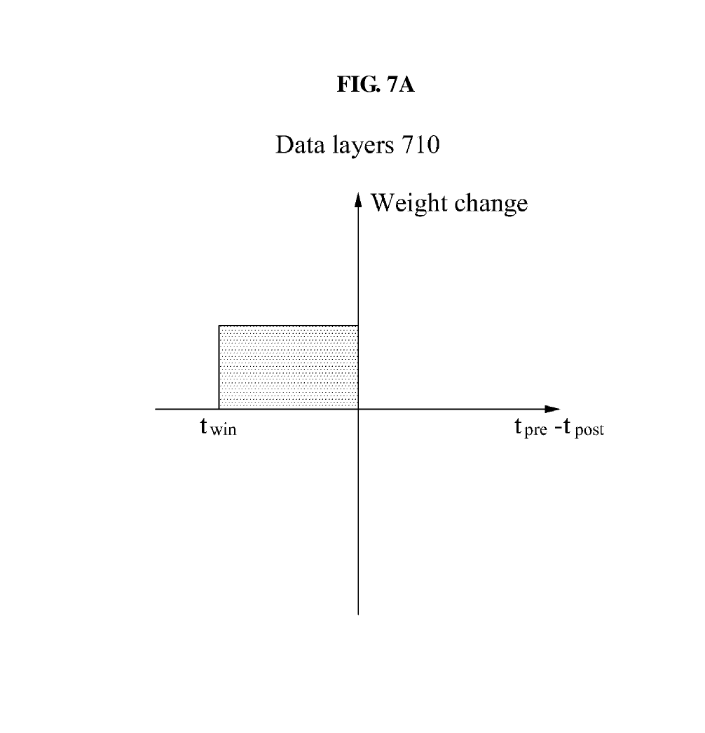

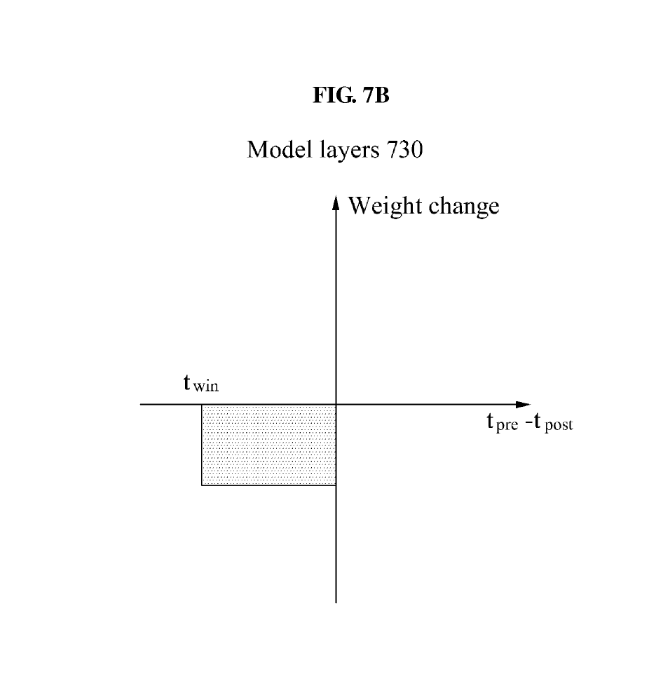

A learning event-based RBM may be driven online by combining a standard method and a spike based learning method biologically inspired and similar to STDP, which will be described with reference to FIG. 7. In implementation of an SNN of the RBM, the learning rule may be used to update a sparse and asynchronous weight.

FIGS. 7A and 7B are diagrams illustrating an timing-based learning scheme in a learning apparatus according to an exemplary embodiment.

Referring to FIG. 7A, in a connection among neurons in data layers 710, a positive weight change may be performed when a presynaptic neuron spikes after a postsynaptic neuron spikes, for example, in a negative time difference. Referring to FIG. 7B, in model layers 730, a converse change by which a combination of identical spikes generates a weight decrease may be generated.

Since two spikes may not easily occur at a same point successively, values of v^{±} and h^{±} may define a windowing period (t_{win}), i.e., a time window, in which the values remain as 1 and then change to 0. More detailed description is provided with reference to FIG. 6.

A rate (E[hₜ]t_{win}) of a number of spikes expected to occur in each window may be a ratio of a window size to an entire unit time length of a rate (rₕᵢ) as expressed in Equation 2.

$${E [ {h}_{i} ]}_{{t}_{win}} = {〈 {h}_{i} 〉}_{{t}_{win}} = \frac{1}{{t}_{win}} {r}_{{h}_{i}} , \qquad [ Equation 2 ]$$

In Equation 2, “< >” denotes an expected number of spikes, and “rₕᵢ” and “t_{win}” denote a firing rate of a unit “hᵢ” and a time window, respectively.

For simplification, the firing rate is assumed to follow a Poisson distribution which is a most generalized assumption in a spike model and thus, the time window in a rate of the Poisson distribution may be an average rate in a selected time section.

In the learning apparatus, the time section may start from t−t_{win} and terminate at a current time (t). In such a limitation, an expected number of hᵢ events generated with respect to a unit time section may be the rate (rₕᵢ).

Thus, an updating rule may be represented by Equation 3.

Δwᵢⱼ∝ [symbol] hᵢ [symbol] t_{win} [symbol] (vⱼ [symbol] t_{win} [symbol] ₊ [symbol] hᵢ [symbol] t_{win} [symbol] vⱼ [symbol] t_{win} [symbol] ₋Δwᵢⱼ∝ [symbol] rₕ_{ᵢ}rᵥⱼ [symbol] ₊− [symbol] rₕ_{ᵢ}rᵥⱼ [symbol] ₋ [Equation 3]

Equation 3 indicates that the learning rule according to exemplary embodiments is consistent with a standard CD rule for an RBM. In Equation 3, spike states, for example, “hᵢ” and “vᵢ,” indicate a presence or an absence of a spike, and the time window (t_{win}) denotes a period of time during which expectation is performed.

Since learning occurs only when spikes are received from all connected layers, calculation for the learning may unconditionally follow a spike-based rule and exceptional cases may be rare. That is, for the learning to occur, a value of hᵢ and a value of vⱼ may need to be 1 and the time window may need to be designed for a spike hᵢ to occur at an end of the window. A weight updating value may be calculated when a hidden layer spikes.

A neuron may verify which inputs spike at a previous t_{win} and whether a weight is potentiated or depressed as specified by the learning rule. The the evtDC learning rule is summarized in the descriptions provided with reference to FIGS. 6 and 7A and 7B.

The evtCD learning rule may need to be evaluated only when a neuron in a hidden layer spikes. The spiking of the neuron of the hidden layer is a product of two binary events and thus, a multiplication of hᵢ and vⱼ may be activated only when the value of both hᵢ and vⱼ is 1. When any one of the two is not activated, the learning apparatus may not update a weight and a connection weight “wᵢⱼ” may be fixed and maintained.

According to an exemplary embodiment, a fast online version of a learning algorithm, which may be achieved in a spiking network, may be implemented. An online machine-learning method according to an exemplary embodiment may allow an unsupervised probabilistic learning approximation through a local plasticity rule similar to STDP. A deep learning network is an exhaustive task and uses a large quantity of computer resources and thus, online learning may not be considered.

According to an exemplary embodiment, efficiency in implementation of an RBM which includes spiking neurons and is irregularly updated, and an additional advantage of the event-based learning rule without updating all weights at a certain point in time may be combined. Most effective use may be found in a case in which such a type of the event-based online learning is combined with effective input representations of neuromorphic sensors which considerably reduce data to be processed.

According to an exemplary embodiment, the online learning for the RBM may automatically adapt to an environmental change and be performed by a user. Thus, the event-based learning may be useful when being used as a portion of a smart device or robot in which inputs previously not experienced may be regularly generated. The learning apparatus may initiate learning using a weight initialized by another machine-learning method, for example, an offline CD method, and apply the weight to an online environment. Using existing technology as a basis for a new product may be enabled and thus, learning may be initiated with the evtCD learning rule without prior knowledge.

Also, an online version of the learning rule to be applied to inputs of dynamic vision sensors and other neuromorphic sensors may be used. That is, the learning apparatus may be an event-based RBM that may directly extract features from spiking sensors in an SNN.

The online learning rule that may directly operate in response to asynchronous output events of event-based sensors may preserve an event timing and avoid artificial binning of spikes. Thus, an additional calculation operation may reduce a processing speed in a neural network. In addition, sparsity of sensor outputs may indicate that an operation load may be less than an equivalent frame-based sensor combined with a time unit network.

The learning rule may be sparse in implementation of an SNN of an RBM, provide an asynchronous weight update, and enable achievement of a desirable performance after only 60 seconds of learning time when exposed to a real-time input from an event-based vision sensor.

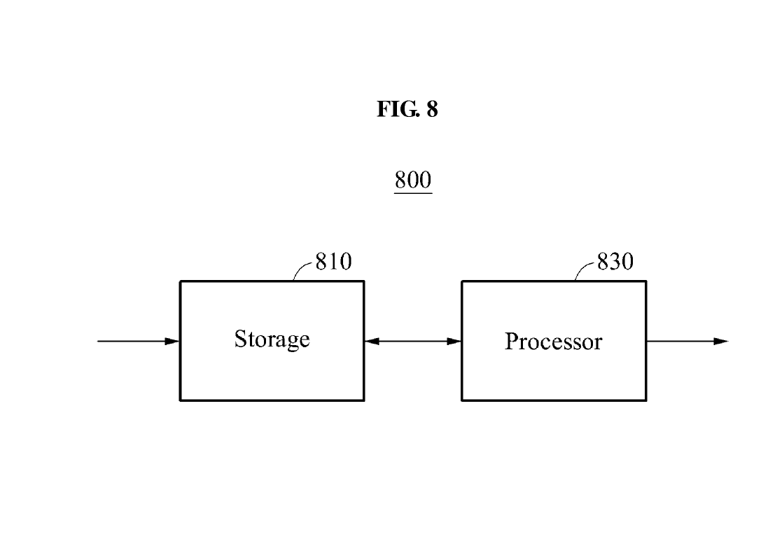

FIG. 8 is a block diagram illustrating a learning apparatus 800 according to an exemplary embodiment.

Referring to FIG. 8, the learning apparatus 800 includes a storage 810 and a processor 830. The storage 810 stores a computer program and the processor 830 simulates a neural network by executing the computer program. The simulated neural network includes a first visible layer, a first hidden layer, a second visible layer, and a second hidden layer. The second visible layer is an auxiliary layer of the first visible layer, and the second hidden layer is an auxiliary layer of the first hidden layer.

Each of the first visible layer, the first hidden layer, the second visible layer, and the second hidden layer may include neurons. The neurons included in the first visible layer, the first hidden layer, the second visible layer, and the second hidden layer may be activated based on a timing of a spike to be input.

The first visible layer may be activated based on input data, and the first hidden layer may be activated based on a learning parameter and an output of the first visible layer. The second visible layer may be activated based on an output of the first hidden layer, and the second hidden layer may be activated based on the learning parameter and an output of the second visible layer. A connection structure between the first visible layer and the first hidden layer may be identical to a connection structure between the second visible layer and the second hidden layer.

The learning parameter may be trained to allow the output of the first hidden layer and the input data to be similar. Also, the learning parameter may be trained to allow the output of the second visible layer and the output of the first visible layer to be similar. The learning parameter may include a connection weight between a neuron in a visible layer and a neuron in a hidden layer.

A connection weight between a first visible neuron in the first visible layer and a first hidden neuron in the first hidden layer may increase based on an output of the first visible neuron and an output of the first hidden neuron. A connection weight between a second visible neuron in the second visible layer and a second hidden neuron in the second hidden layer may decrease based on an output of the second visible neuron and an output of the second hidden neuron.

The connection weight between the first visible neuron and the first hidden neuron may increase when a difference between a timing of a spike to be output by the first visible neuron and a timing of a spike to be output by the first hidden layer is within a predetermined time range, i.e., a time window of FIG. 7A. The connection weight between the second visible neuron and the second hidden neuron may decrease when a difference between a timing of a spike to be output by the second visible neuron and a timing of a spike to be output by the second hidden layer is within a predetermined time range, i.e., a time window of FIG. 7B.

The above-described exemplary embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the exemplary embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as code produced by a compiler, and files containing higher level code that may be executed by the computer using an interpreter. The described hardware devices may be configured to act as one or more software modules in order to perform the operations of the above-described exemplary embodiments, or vice versa.

Although a few exemplary embodiments have been shown and described, the present inventive concept is not limited thereto. Instead, it will be appreciated by those skilled in the art that changes may be made to these exemplary embodiments without departing from the principles and spirit of the disclosure, the scope of which is defined by the claims and their equivalents.

What is claimed is:

1. A method for a machine-learning apparatus to train a learning parameter for simulating a neural network, the method comprising:
activating a first visible layer based on input data;
activating a first hidden layer based on a first learning parameter of the first visible layer and the first hidden layer and an output of the first visible layer;
training the first learning parameter based on the output of the first visible layer and an output of the first hidden layer;
activating a second visible layer corresponding to an auxiliary layer of the first visible layer based on the output of the first hidden layer;
activating a second hidden layer corresponding to an auxiliary layer of the first hidden layer based on a second learning parameter of the second visible layer and the second hidden layer and an output of the second visible layer; and
training the second learning parameter based on the output of the second visible layer and an output of the second hidden layer.

2. The method of claim 1, wherein the first learning parameter represents a connection structure between the first visible layer and the first hidden layer, the second learning parameter represents a connection structure between the second visible layer and the second hidden layer, and the first learning parameter is identical to the second learning parameter.

3. The method of claim 1, wherein the training the first learning parameter comprises training the first learning parameter so that the output of the first hidden layer is similar to the input data, and
wherein the training the second learning parameter comprises training the second learning parameter so that the output of the second visible layer is similar to the output of the first visible layer.

4. The method of claim 1, wherein the first learning parameter comprises a first connection weight between a neuron comprised in the first visible layer and a neuron comprised in the first hidden layer, and
wherein the second learning parameter comprises a second connection weight between a neuron comprised in the second visible layer and a neuron comprised in the second hidden layer.

5. The method of claim 1, wherein neurons comprised in the first visible layer, the first hidden layer, the second visible layer, and the second hidden layer are activated based on a timing of a spike to be input.

6. The method of claim 4, wherein the first connection weight between a first visible neuron comprised in the first visible layer and a first hidden neuron comprised in the first hidden layer increases based on an output of the first visible neuron and an output of the first hidden neuron, and
the second connection weight between a second visible neuron comprised in the second visible layer and a second hidden neuron comprised in the second hidden layer decreases based on an output of the second visible neuron and an output of the second hidden neuron.

7. The method of claim 6, wherein the first connection weight between the first visible neuron and the first hidden neuron increases when a timing of a spike output by the first visible neuron and a timing of a spike output by the first hidden layer are within a predetermined time range.

8. The method of claim 6, wherein the second connection weight between the second visible neuron and the second hidden neuron decreases when a timing of a spike output by the second visible neuron and a timing of a spike output by the second hidden layer are within a predetermined time range.

9. A computer program stored in a non-transitory computer-readable recording medium to implement the method of claim 1.

10. A learning apparatus, comprising:
a storage configured to store a computer program including instructions to simulate a neural network; and
a processor configured to perform a method for training a learning parameter used in the neutral network by executing the computer program, the method comprising:
activating a first visible layer based on input data;
activating a first hidden layer based on a first learning parameter of the first visible layer and the first hidden layer and an output of the first visible layer;
training the first learning parameter based on the output of the first visible layer and an output of the first hidden layer;
activating a second visible layer corresponding to an auxiliary layer of the first visible layer based on the output of the first hidden layer;
activating a second hidden layer corresponding to an auxiliary layer of the first hidden layer based on a second learning parameter of the second visible layer and the second hidden layer and an output of the second visible layer; and
training the second learning parameter based on the output of the second visible layer and an output of the second hidden layer.

11. The learning apparatus of claim 10, wherein the first learning parameter represents a connection structure between the first visible layer and the first hidden layer, the second learning parameter represents a connection structure between the second visible layer and the second hidden layer, and the first learning parameter is identical to the second learning parameter.

12. The learning apparatus of claim 10, wherein the first learning parameter is trained so that the output of the first hidden layer is similar to the input data and the second learning parameter is trained so that the output of the second visible layer is similar to the output of the first visible layer.

13. The learning apparatus of claim 10, wherein the first learning parameter comprises a first connection weight between a neuron comprised in the first visible layer and a neuron comprised in the hidden layer, and
wherein the second learning parameter comprises a second connection weight between a neuron comprised in the second visible layer and a neuron comprised in the second hidden layer.

14. The learning apparatus of claim 10, wherein neurons comprised in the first visible layer, the first hidden layer, the second visible layer, and the second hidden layer are activated based on a timing of a spike to be input.

15. The learning apparatus of claim 13, wherein the first connection weight between a first visible neuron comprised in the first visible layer and a first hidden neuron comprised in the first hidden layer increases based on an output of the first visible neuron and an output of the first hidden neuron, and
the second connection weight between a second visible neuron comprised in the second visible layer and a second hidden neuron comprised in the second hidden layer decreases based on an output of the second visible neuron and an output of the second hidden neuron.

16. The learning apparatus of claim 15, wherein the first connection weight between the first visible neuron and the first hidden neuron increases when a timing of a spike output by the first visible neuron and a timing of a spike output by the first hidden layer are within a predetermined time range.

17. The learning apparatus of claim 15, wherein the second connection weight between the second visible neuron and the second hidden neuron decreases when a timing of a spike output by the second visible neuron and a timing of a spike output by the second hidden layer are within a predetermined time range.
